(19) United States
(12) Patent Application Publication
(10) Pub. No.: US 2003/0160558 A1
(43) Pub. Date: Aug. 28, 2003

(54) Low-carbon steel sheet for mask of tension type cathode ray tube with bridge and mask and cathode ray tube

(76) Inventors: Hideharu Ohmae, Osaka (JP); Toshiharu Hoshi, Osaka (JP); Hideki Matsuoka, Tokyo (JP); Kenji Tahara, Tokyo (JP); Kenichi Mitsuzuka, Tokyo (JP); Kazuhiro Taki, Kanagawa (JP); Tetsuo Kawahara, Kanagawa (JP); Norio Yuki, Ibaraki (JP)

Correspondence Address: BIRCH STEWART KOLASCH & BIRCH, PO BOX 747, FALLS CHURCH, VA, 22040-0747, US

(21) Appl. No.: 10/258,120

(22) PCT Filed: Apr. 19, 2001
(86) PCT No.: PCT/JP01/03336

(30) Foreign Application Priority Data
Apr. 21, 2000 (JP) 2000-120659

(51) Int. Cl. H01J 29/80; C22C 38/00

(52) U.S. Cl. 313/402; 148/320; 420/8

(57) ABSTRACT

A low-carbon steel sheet for a mask for use in a tension type cathode ray tube with bridge, characterized in that it has a chemical composition, in mass %:C:0.001 to 0.015%, Si:0.020% or less, Mn:0.2 to 1.8%, P:0.02% or less, S:0.010% or less, ON: more than 0.010% and not more than 0.025%, Al:0.02% or less, O:0.010% or less and balance:Fe and inevitable impurities, with the proviso that (N mass %—0.52 Al mass %) is 0.005% or more. The low-carbon steel sheet can prevent the lowering of shielding capacity due to terrestrial magnetism.

### TECHNICAL FIELD

The present invention relates to low-carbon steel sheet used for the color-selecting electrode or the mask of a bridge-attached tension-type cathode ray tube. More particularly, the present invention relates to low-carbon steel sheet having improved creep, etching and magnetic properties.

### BACKGROUND TECHNIQUE

A tension-type color-selecting electrode known as Trinitron tube uses an aperture-grill mask. In this mask, a cold-rolled steel sheet is etched to form a number of slits, and tension is then applied to this sheet in the direction of the slits. The sheet under the tension is stretched on a frame. However, disadvantages are involved in that the slit shape is detrimentally impaired, i.e., the so-called line distortion, when flatness of the cold-rolled steel sheet is poor, or the residual stress of the cold-rolled steel sheet is large. Disadvantages are involved in the cathode-ray tube in that the terrestrial magnetism displaces the trajectory of the electron beam and color heterogeneity is incurred. Since the apertures of the aperture-grill mask are etched in a parallel-elongated pattern, the aperture ratio on the surface of the metallic material is so high that the magnetic shielding characteristics are impaired. A correcting magnetic circuit is, therefore, indispensable in the aperture-grill type cathode ray tube. In addition, since a sound source such as a speaker and the like vibrates the mask, damper-wires must be extended across each of the slits so as to suppress the vibration of the mask. Disadvantageously, these damper-wires are projected and are discernible on a display, and they also complicate the structure of the mask and frames.

A novel type tension mask, i.e., the bridge-attached tension mask, can overcome the above-described disadvantages of the aperture-grill mask and utilizes the advantages of both an aperture-grill mask and a shadow mask. In this bridge-attached tension mask, the etching is carried out in a pattern similar to that of the conventional shadow mask. The so-treated mask is not pressed but is stretched on a frame while being subjected to tension in the vertical or perpendicular direction between the upper and lower sides of a cathode-ray tube. In this type of mask, not thin long slits but apertures in the form of slots similar to those of a shadow mask are formed. A number of thin metal wires, referred to as the bridges, are selectively left by means of etching the sheet between the longitudinal metal wires. These bridges can prevent the longitudinal wires from twisting and hence the so-called line distortion. In addition, the area of metallic material in the mask is high due to the bridges so that the magnetic shielding characteristics can be enhanced. Furthermore, no damper wires are necessary for suppressing the mask vibration due to a sound source such as a speaker.

Mild steel used at present for the aperture-grill mask was used for the bridge-attached tension mask and treated as follows. The etching was carried out to form the horizontal bridges as thin as possible so as to attain brightness of the same level as that attained in the aperture-grill mask. The blackening treatment was then applied to enhance the anti-doming property. The mask was subjected to tension. The so produced color-selecting electrode of a cathode-ray tube was baked so as to remove impurities and relieve the stress. Then, a phenomenon of wrinkle formation was observed. This phenomenon was investigated in detail, and the following facts were found. Namely, when the mask is exposed under heat and load for a long period of time, the creep phenomenon of the material results in excessive elongation and hence wrinkles.

Heretofore, Japanese Unexamined Patent Publication No. 5-311,332 proposes to improve the creep property of aperture grill material as follows. The proposed material consists of from more than 0.001% to 0.030% of C, from 0.6% to 3.00% of Mn, from more than 0.010% up to 0.100% of N as the basic components, and balance of Fe and unavoidable impurities. The material may contain as the auxiliary additives (a) from 0.10% to 4.00% of W and/or Ni and/or (b) from 0.001% to 0.5% of Nb, V, Ti, Zr, Ta and/or B. The other components are limited as follows: Si—0.05%; P—0.02%; S—0.015%; Al—0.020% or less; and O—0.010% or less. In this publication, Mn and N simultaneously added in appropriate amount bring about interaction to improve the creep property. However, the magnetic shielding properties are not taken into consideration.

### DISCLOSURE OF INVENTION

The material proposed in the Japanese publication mentioned above was investigated. Improvement in the creep property due to the interaction of Mn and N could be affirmed in the bridge-attached tension type mask as well. However, Al interferes with this interaction. Mn seriously impairs the magnetic shielding property and makes the material very liable to be influenced by terrestrial magnetism. As a result of such investigation, it turned out that the material of the bridge-attached tension mask should be developed from a point of view different from that of the material for the known aperture-grill type mask. The advantages of the bridge-attached tension mask should be fully utilized in the material developed. The present inventors performed research of material appropriate for the mask and the etching property. The present inventors also performed intensive research of the conditions of heat-treatment and the tension force applied to the mask for assembling the color-selecting electrode of a cathode-ray tube. Finally, the present inventors successfully developed material which does not incur wrinkle formation, and which exhibits improved magnetic shielding property.

Namely, the material composition discovered by the present invention involves a recognition that the N and Mn contents of the conventional Al-killed steel sheet are limited to an appropriate range, and, further, the Al, C, O, S, Si and P contents are limited to further narrow ranges.

In addition, the reduction ratio of the final cold-rolling of an Al-killed steel sheet is limited to an appropriate range. As a result, stable and high creep strength could be obtained, and reduction of the magnetic shielding property could be successfully suppressed to a minimum level.

Based on the above-described discoveries, there is provided a low-carbon steel sheet used for the color-selecting electrode of a bridge-attached tension type cathode-ray tube, which consists, by mass %, of from 0.001 to 0.015% of C, 0.020% or less of Si, from 0.2 to 1.8% of Mn, 0.02% or less of P, 0.010% or less of S, from more than 0.010% to 0.025% of N, 0.020% or less of Al, 0.010% or less of O, the balance being Fe and unavoidable impurities, (N mass %—0.52Al mass %) being 0.005% or more. There is also provided a low-carbon steel sheet used for the color-selecting electrode of a bridge-attached tension type cathode-ray tube, which consists, by mass %, of from 0.001 to 0.015% of C, 0.020% or less of Si, from 0.2 to 1.8% of Mn, 0.02% or less of P, 0.010% or less of S, from more than 0.010% to 0.025% of N, 0.020% or less of Al, 0.010% or less of O, the balance being Fe and unavoidable impurities, (N mass %—0.52Al mass %) being 0.005% or more, said ratio sheet being rolled at from 15 to 80% of the final cold-rolling reduction ratio.

There is furthermore provided a bridge-attached tension-type color-selecting electrode of a cathode ray tube, in which the sheet described above is appropriately treated as described hereinafter and is assembled.

There is also provided a cathode-ray tube, which comprises the bridge-attached tension-type color-selecting electrode.

The significance of the numerical limitations described above is described hereinafter.

The features of the low-carbon steel sheet used for the color-selecting electrode of a bridge-attached tension type cathode-ray tube (hereinafter referred to as “the steel sheet for bridge-attached tension type mask”) are described below.

C: C is a component for enhancing the creep strength of the steel sheet for the bridge-attached tension type mask. When the C content is too low, the strength is low. On the other hand, when the C content is too high, the etching property and magnetic properties are impaired. The C content is, therefore, from 0.001 to 0.015%.

Si: Si is limited to 0.020% or less, because Si impairs the etching property. Since Si has no appreciable effect for enhancement of the creep property and the like of the steel sheet for the bridge-attached tension type mask, the Si content is limited from the viewpoint of the etching property.

Mn: Mn is a substitutional solute element of Fe. An interaction between Mn and N is generated at the baking temperature in a range of from 673K (400° C.) to 773K (500° C.). Movement of N, which adheres on the dislocations, is impeded by the interaction, so that the creep strength is enhanced. This effect is unsatisfactory at less than 0.2% of Mn. On the other hand, the magnetic properties are impaired at Mn content exceeding 1.8%. The Mn content is, therefore, limited in the range of from 0.2 to 1.8%.

P: P impairs the etching property. The P content is, therefore, limited to 0.02% or less.

S: S forms the sulfide-based non-metallic inclusions. S not only impairs the etching property and the magnetic properties but also fixes Mn, which should participate in the interaction, and nullifies the effect of Mn. The S content is, therefore, limited to 0.010% or less.

N: N is an interstitial solute element of Fe. The solute N impedes movement of dislocations and hence enhances the creep strength. Creep strength is greatly increased due to the interaction between Mn and N by baking in the temperature range of from 673K (400° C.) to 773K (500° C.). This effect is outstanding at the N content exceeding 0.010%. On the other hand, when the N content exceeds 0.025%, the magnetic properties are seriously impaired so that the electron beams are mislanded under the influence of terrestrial magnetism, to which the cathode-ray tube is exposed. The N content is, therefore, 0.025% at the maximum.

Al: Al is necessary for producing the Al-killed steel and is also combined with N to form the nitrides. When N is fixed as the nitrides, contribution of N, to enhance the creep strength, is suppressed and the magnetic properties are impaired. The Al content is, therefore, 0.02% at the highest. The lowest Al content is preferably 0.003%.

O: O forms an oxide inclusion and impairs the etching property and magnetic properties. The O content is, therefore, 0.010% at the highest.

(N mass %—0.52Al mass %): As is described hereinabove, when N and Al form nitrides, contribution of N to enhance the creep strength is suppressed. The N content must, therefore, be controlled in an appropriate amount relative to the Al content. Specifically, the N and Al contents are adjusted to provide 0.005% or more of (N mass %—0.52Al mass %).

The components other than the above mentioned ones are such impurities as Cu, Sn, Cr, Ni, B, Ti and Nb, and Fe.

The steel material having the above-mentioned composition is hot-rolled and then subjected to repeated cold-rolling and annealing. The so-wrought steel sheet is, for example, of from 0.05 to 0.2 mm thickness. The amount of composition is adjusted taking into consideration of such properties as creep strength, etching property, and magnetic properties required for a particular bridge-attached tension type mask. The amount of composition is also adjusted taking into consideration of the descriptions hereinabove. The closer the composition is to pure iron, the better the etching property and magnetic properties. The creep property is better as the Mn and N contents are higher. The composition is, therefore, adjusted so as to adapt these properties to the desired levels. These properties are also influenced by such production conditions as the rolling reduction ratio and heat treatment. For example, when the magnetic properties do not arrive at the desired level under a certain production condition, then the composition is adjusted to a low Mn level.

The steel sheet for a bridge-attached tension type mask must have good handling property. In addition, in order to stretch a steel sheet as the mask, the tension force should be stably applied to the steel sheet. It is effective to adjust the reduction ratio of the final cold rolling according to (claim 2) for attaining the creep property and strength required for the handling property and stable application of tension. The lowest level of strength required in the light of handling property and of preventing deformation and rupture of a mask during stretching of the mask is 450 MPa of tensile strength and 360 MPa of yield strength (0.2%). Particularly, the creep property is improved with the increase in cold-rolling reduction ratio. Therefore, when the cold-rolling reduction ratio is high, the Mn and N contents can be kept at such low level as to attain good magnetic properties. The upper level of strength, where the creep property and magnetic properties are balanced, is 850 MPa of both tensile strength and yield strength (0.2%).

When the reduction ratio of the final cold-rolling is low, the strength is low, and the cold-working contributes to only slight improvement of the creep property. The reduction ratio of the final cold-rolling is, therefore, 15% or more. On the other hand, when the reduction ratio of the final cold-rolling is too high, the load to a rolling mill is so heavy that inconveniences are incurred in the practical mass production. The upper limit of reduction ratio of the final cold-rolling is, therefore, limited to 80% or less. It is possible to adjust, by means of the final cold-rolling mentioned above, the tensile strength perpendicular to the rolling direction in a range of from 450 to 850 MPa (claim 4), or the yield strength (0.2%) in the range of from 360 to 850 MPa (claim 5).

According to the discoveries by the present inventors, the grain size prior to the final cold-rolling exerts influence on the magnetic shielding properties of the finally cold-rolled material including the finally cold-rolled and then heat-treated material described hereinbelow (claim 3). More specifically, when the grain size prior to the final cold-rolling is too fine, the grain boundaries of the finally cold-rolled material including the finally cold-rolled and then heat-treated material impede the movement of magnetic walls, making the magnetization of such materiel difficult. As a result, the soft magnetic properties become poor. The magnetic properties of the finally cold-rolled material including the finally cold-rolled and then annealed material are appreciably improved, when the grain size of the material prior to the final cold rolling is 5 μm or more. A preferred lowest limit of grain size prior to the final cold rolling is, therefore, 5 μm or more. On the other hand, when the grain size prior to the final cold rolling is too large the creep property of the finally cold-rolled material including the finally cold-rolled and then annealed material is poor. In addition, since the steel having the composition according to the present invention is difficult to recrystallize, economically disadvantageous long time is necessary in the annealing prior to the final cold-rolling to obtain the grain size larger than 50 μm in the stage prior to the final cold rolling. A preferred highest limit of grain size prior to the final cold-rolling is therefore 50 μm. The temperature of intermediate annealing is appropriately adjusted to induce the recrystallizing grain growth in the range described above prior to the final cold- rolling.

The cold-rolled sheet according to the present invention is cut into the form of a mask. The mask is then etched to form apertures in the form of dots or slots. Tension is then applied to the mask to stretch it. The mask is then bonded on a frame. The magnetic properties are improved by heat-treatment of the mask before application of tension (claim 7). When the heat-treating temperature is lower than 723K (450° C.), since the relief of stress induced in the aperture-forming step is unsatisfactory, the improvement in the magnetic properties is also unsatisfactory. On the other hand, when the heat-treating temperature is higher than 823K (550° C.), the creep property is seriously impaired. For this reason, a preferred lowest temperature is 723K (450° C.), and a preferred highest temperature is 823K (550° C.) for the heat-treatment.

Blackening treatment is usually carried out in the production process of a shadow mask to form iron oxide on the surface of the mask to blacken it, thereby preventing the doming due to thermal expansion. However, in the case of the bridge-attached tension mask, the heat-treatment described above and the blackening treatment can be carried out simultaneously (claim 9). The blackening and improvement of magnetic properties are therefore simultaneously attained. This method enables low-cost production of the color-selecting electrode of a cathode-ray tube, having improved magnetic properties.

The tension application in the bridge-attached tension mask is at a lower level than in the aperture-grill mask. When the applied tension is too low, a vibration problem occurs. On the other hand, when the applied tension is too high, wrinkles are formed on the mask. The tension force is, therefore, preferably in the range of from 100 to 300 MPa (claim 10).

### BRIEF EXPLANATION OF DRAWING

FIG. 1 is a graph showing a relationship of the displacement of electron-beam trajectory (%, relative to the conventional) dependent upon the Br/Hc ratio (unit of Br is Gauss=10⁴ T (tesla)).

### BEST MODE FOR CARRYING OUT INVENTION

The present invention is described with reference to the examples.

### EXAMPLE 1

The test materials having various compositions as shown in Table 1 were smelted in a vacuum-melting furnace. Hot-rolling and cold-rolling were carried out to reduce sheet thickness to 0.2 mm. The wrought material was annealed in hydrogen+nitrogen atmosphere to obtain 5 μm of average grain size. The cold-rolling was then carried out to reduce sheet thickness to 0.1 mm (reduction ratio being 50%). From the resultant steel sheet, a creep specimen (based on JIS 13 B specimen) and a strip specimen (3 mm W×150 mmL) for measurement of magnetic properties were cut parallel to the rolling direction. These specimens were heat-treated in carbon dioxide atmosphere at 783K (510° C.) for 55 minutes and subjected to measurement.

In the creep test, 200 MPa of tensile stress was applied to the specimen at temperature of 733K (460° C.) for 60 minutes. The creep elongation was then measured. In the measurement of magnetic properties, the direct-current magnetic properties (B-H curve) were measured under 200 Mpa of load, which corresponds to the tensile load. The measurement results are shown in Table 1.

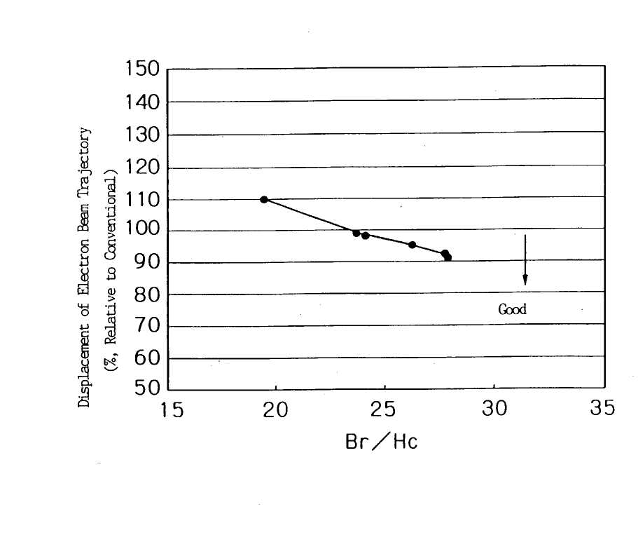

The shielding property of the mask is to prevent displacement of an electron beam, i.e., mislanding, under the influence of terrestrial magnetism, as described hereinabove. The shielding property is greatly influenced by the magnetic properties of the steel sheet for the bridge-attached tension mask. FIG. 1 shows a relationship assured by the experiments between the displacement of an electron beam in the bridge-attached tension mask according to the present invention and the magnetic properties of a mask under tension of 200 MPa. There is a relationship between Br/Hc (Br: the remanent flux density, unit being Gauss, and Hc: coercive force) and the displacement of the beam as shown in FIG. 1. In FIG. 1, 100 denotes the displacement of the electron-beam trajectory in a cathode ray tube produced by the conventional tension-type (the aperture grill). When the Br/Hc of the bridge-attached tension-mask is 23 or more, the displacement of the beam trajectory is less than that of the conventional mask. Based on this discovery, Br/Hc is used as an index of the magnetic properties. The chemical composition of steel is limited as set forth in claims 1 and 2 to attain 23 or more of Br/Hc in the bridge-attached tension type cathode-ray tube.

In Table 1, the nitrogen contents are varied in the specimens Nos. 1-6. When the nitrogen content is 0.008% or less, the creep strength is as high as 0.28% or more. The lowest nitrogen content is, therefore, set at more than 0.010%. On the other hand, the magnetic properties (Br/Hc) are more impaired as the nitrogen content is higher. Br/Hc is less than 23 at 0.029% of the nitrogen content. The upper nitrogen content is, therefore, set at 0.025%.

The nitrogen content is appropriate, but the manganese content is as low as 0.14% in Sample No. 7. The creep property is, therefore, poor in Sample No. 7. The lowest manganese content is, therefore, set as 0.2%. On the other hand, when the manganese content is as high as 2.0% as in Sample No. 10, the magnetic properties are drastically impaired. The highest manganese content is, therefore, set at 1.8%.

Both the manganese and nitrogen contents fall within the inventive ranges in Sample No. 8. However, the Al content is so high that the creep property is poor. The Al content is, therefore, set at 0.020% or less. The C content is so low in Sample No. 11 that the creep property is poor. The C content is so high in Sample No. 12 that the magnetic properties are seriously poor. Based on these results, the C content is set in a range of from 0.001 to 0.015%.

TABLE 1

| | | | | | | | | | | Creep | | | | | |
|---|---|---|---|---|---|---|---|---|---|---|---|---|---|---|---|
| | | | | | | | | | N % 0.52 | Elongation | Hc | Br | (mass %) | | |
| No | C | Si | Mn | P | S | N | Al | O | Al %) | (%) | (A/m) | (T) | μM | Br/Hc | Remarks |
| 1 | 0.008 | 0.01 | 0.60 | 0.013 | 0.003 | 0.003 | 0.009 | 0.002 | −0.00168 | 0.35 | 380.5 | 1.003 | 1210 | 26.4 | Outside Claim 1 |
| 2 | 0.008 | 0.01 | 0.60 | 0.015 | 0.005 | 0.008 | 0.009 | 0.002 | 0.00332 | 0.28 | 390.0 | 1.001 | 1080 | 25.7 | Outside claim 1 |
| 3 | 0.007 | 0.01 | 0.62 | 0.018 | 0.006 | 0.011 | 0.007 | 0.001 | 0.00736 | 0.17 | 406.0 | 0.999 | 1071 | 24.6 | Inside claim 1 |
| 4 | 0.007 | 0.01 | 0.58 | 0.015 | 0.006 | 0.013 | 0.007 | 0.002 | 0.00936 | 0.16 | 421.9 | 0.998 | 1064 | 23.7 | Inside claim 1 |
| 5 | 0.008 | 0.02 | 0.58 | 0.017 | 0.004 | 0.022 | 0.008 | 0.002 | 0.01784 | 0.14 | 428.1 | 0.998 | 1043 | 23.3 | Inside claim 1 |
| 6 | 0.008 | 0.01 | 0.59 | 0.015 | 0.006 | 0.029 | 0.006 | 0.001 | 0.02588 | 0.13 | 485.6 | 0.990 | 910 | 20.4 | Outside claim 1 |
| 7 | 0.009 | 0.01 | 0.14 | 0.015 | 0.006 | 0.015 | 0.009 | 0.002 | 0.01032 | 0.30 | — | — | — | — | Outside claim 1 |
| 8 | 0.007 | 0.02 | 0.61 | 0.012 | 0.002 | 0.013 | 0.022 | ≦0.001 | 0.00156 | 0.27 | 382.1 | 0.950 | 1120 | 24.9 | Outside claim 1 |
| 9 | 0.008 | 0.01 | 1.1 | 0.012 | 0.006 | 0.014 | 0.009 | 0.003 | 0.00932 | 0.19 | 422.0 | 0.980 | 1100 | 23.2 | Inside Claim 1 |
| 10 | 0.008 | 0.01 | 2.0 | 0.013 | 0.005 | 0.013 | 0.008 | 0.004 | 0.00884 | 0.12 | 421.0 | 0.880 | 990 | 20.9 | Outside Claim 1 |
| 11 | 0.0006 | 0.01 | 0.52 | 0.012 | 0.006 | 0.013 | 0.007 | 0.004 | 0.00936 | 0.24 | — | — | — | — | Outside Claim 1 |
| 12 | 0.019 | 0.01 | 0.53 | 0.011 | 0.003 | 0.014 | 0.008 | 0.003 | 0.00984 | 0.13 | 477.6 | 0.788 | 1000 | 16.5 | Outside Claim 1 |

Hc: Coercive Force
Br: Remanent Flux Density
μm: Maximum Pearmeablity

### EXAMPLE 2

A sample having the composition of No. 4 in Table 1 was cold-rolled at 80% or less of reduction ratio to 0.1 mm thick sheet. From the resultant steel sheet, a tensile specimen (based on JIS 13 B specimen) was cut in a direction perpendicular to the rolling direction, and a creep test specimen (based on JISB 13 specimen) was cut in a direction parallel to the rolling direction. The creep specimen was heat-treated in carbon dioxide atmosphere at 783K (510° C.) for 55 minutes and subjected to measurement. In the creep test, 200 MPa of tensile stress was applied to the specimen at temperature of 733K (460° C.) for 60 minutes. The creep elongation was then measured. The measurement results are shown in Table 2.

As is apparent from Table 2, the creep elongation is large in the annealed sample, which was not then cold-rolled at all after annealing. The creep elongation decreases as the reduction ratio increases. When the reduction ratio is 17%, no wrinkles are formed on the bridge-attached tension mask according to the present invention.

TABLE 2

| Final Cold- | | | | |
|---|---|---|---|---|
| Rolling | | | | |
| Reduction | Creep | Tensile | Yield | |
| Ratio | Elongation | Strength | Strength(0.2%) | |
| (%) | (%) | (MPa) | (MPa) | Remarks |
| 0 | 0.62 | — | — | Outside Claim 2 |
| 8 | 0.35 | — | — | Outside Claim 2 |
| 12 | 0.29 | — | — | Outside Claim 2 |
| 15 | — | 453 | 365 | Inside Claim 2 |
| 17 | 0.18 | — | — | Inside Claim 2 |
| 50 | 0.16 | — | — | Inside Claim 2 |
| 70 | 0.14 | — | — | Inside Claim 2 |
| 80 | 0.14 | 843 | 843 | Inside Claim 2 |

### EXAMPLE 3

A sample having the composition of No. 4 shown in Table 1 was rolled to 0.2 mm thick sheet. The rolled material was heat-treated at various temperatures to vary the grain size. The cold-rolling was then carried out to reduce sheet thickness to 0.1 mm t (final reduction ratio—50%). From the resultant steel sheet, a creep specimen (based on JIS 13 B specimen) and a strip specimen (3 mm W and 150 mm L) for measurement of magnetic properties were cut parallel to the rolling direction. These specimens were heat-treated at 783K (510° C.) for 55 minutes and subjected to measurement.

In the creep test, 200 MPa of load was applied to the specimen at temperature of 733K (460° C.) for 60 minutes. The creep elongation was then measured. In the measurement of magnetic properties, the direct current magnetic properties (B-H curve) were measured under application of 200 Mpa of load. The measurement results are shown in Table 3. As is shown in Table 3, the magnetic properties are poor when the grain size is 4 μm or less. When the grain size is 70 μm the magnetic properties are not very much improved, while the creep property is drastically impaired.

TABLE 3

| Grain | | | | Creep | | |
|---|---|---|---|---|---|---|
| Size | Hc | Br | | Elongation | | |
| (μm) | (A/m) | (T) | μM | (%) | Br/Hc | Remarks |
| ≦4 | 453.7 | 0.880 | 990 | 0.15 | 19.4 | Outside Claim 3 |
| 5 | 421.9 | 0.998 | 1064 | 0.16 | 23.7 | Inside Claim 3 |
| 10 | 413.9 | 0.999 | 1077 | 0.16 | 24.1 | Inside Claim 3 |
| 25 | 390.0 | 1.020 | 1095 | 0.16 | 26.3 | Inside Claim 3 |
| 50 | 374.1 | 1.036 | 1105 | 0.19 | 27.3 | Inside Claim 3 |
| 70 | 374.1 | 1.041 | 1111 | 0.25 | 27.8 | Outside Claim 3 |

### EXAMPLE 4

A sample having the composition of No.4 shown in Table 1 and 0.2 mm of sheet thickness was annealed and then cold-rolled to reduce the thickness to 0.1 mm (the final cold-rolling reduction ratio being—50%). The blackening treatment was then carried out in CO₂-gas atmosphere at various temperatures. From the resultant steel sheet, a creep specimen (based on JIS13B specimen) and a strip specimen (3 mm W and 150 mm L) for measurement of magnetic properties were cut parallel to the rolling direction. In the creep test, 270 MPa of tensile stress was applied to the specimen at temperature of 733K (460° C.) for 60 minutes. The creep elongation was then measured. In the measurement of magnetic properties, the direct-current magnetic properties (B-H curve) were measured under application of 270 MPa of load. The measurement results are shown in Table 4. As is apparent from Table 4, the magnetic properties are enhanced with the rise in blackening temperature. The magnetic properties are remarkably enhanced particularly at 723K (450° C.) or higher. The magnetic properties are satisfactory at 803K (530° C.) or higher. On the other hand, when the heat-treating temperature is 803K (530° C.) or higher, the creep property is seriously impaired. Since 270 MPa of the load in the present example is higher than those of the preceding examples, the magnetic property in terms of Br/Hc is impaired. It is apparent that the magnetic property can be improved to a satisfactory level by means of selecting the heat-treating temperature, the reduction ratio and the grain size.

TABLE 4

| Temperature | Creep | | | | | |
|---|---|---|---|---|---|---|
| (K) × | Elongation | Hc | Br | | | |
| 55 minutes | (%) | (A/m) | (T) | μm | Br/Hc | Remarks |
| No heat | 0.11 | 477.6 | 0.420 | 597 | 10.9 | Outside |
| Treatment | | | | | | Claims 7, 8 |
| 573 | 0.13 | 453.7 | 0.475 | 701 | 10.5 | Outside |
| | | | | | | Claims 7, 8 |
| 723 | 0.14 | 374.1 | 0.601 | 960 | 16.1 | Inside |
| | | | | | | Claims 7, 8 |
| 783 | 0.17 | 358.2 | 0.612 | 988 | 17.1 | Inside |
| | | | | | | Claims 7, 8 |
| 803 | 0.18 | 345.4 | 0.798 | 1056 | 23.1 | Inside |
| | | | | | | Claims 7, 8 |
| 823 | 0.19 | 342.3 | 0.830 | 1110 | 24.2 | Inside |
| | | | | | | Claims 7, 8 |
| 843 | 0.32 | 342.3 | 0.835 | 1123 | 24.4 | Outside |
| | | | | | | Claims 7, 8 |
| 873 | 0.66 | 334.3 | 0.841 | 1131 | 25.2 | Outside |
| | | | | | | Claims 7, 8 |

### EXAMPLE 5

A sample having the composition of No.4 shown in Table 1 and 0.2 mm of sheet thickness was annealed and then cold-rolled to reduce the thickness to 0.1 mm. The blackening treatment was carried out in CO₂-gas atmosphere at 783K (510° C.) for 55 minutes. Tension at various levels was applied to the so-treated material and heat-treatment was carried out at 733K (460° C.) for 60 minutes. The generation of wrinkles and vibration characteristics were investigated. The results are shown in Table 5. As is apparent from Table 5, when the tensile stress is low, the vibration property is not acceptable. The vibration property is acceptable at 100 MPa of tensile stress. The wrinkles are liable to form when the tensile stress is high. That is, the wrinkles are formed at 350 MPa.

TABLE 5

| Tensile | | | |
|---|---|---|---|
| Stress | Vibration | | |
| (MPa) | Property | Wrinkles | Remarks |
| 50 | X | X | Outside Claim 10 |
| 100 | Δ | ◯ | Inside Claim 10 |
| 200 | ◯ | ◯ | Inside Claim 10 |
| 300 | ◯ | ◯ | Inside Claim 10 |
| 350 | ◯ | Δ | Outside Claim 10 |

Vibration Property
◯ . . . good
Δ . . . within usable range
X . . . vibration of mask easily occurs due to resonance
Wrinkles
◯ . . . no generation of wrinkles
Δ . . . slight generation of wrinkles
X . . . generation of wrinkles

Industrial Applicability

As is described hereinabove, the creep property, which is required for the material of the color-selecting electrode of a bridge-attached tension type cathode ray tube, is improved mainly by the interaction of Mn and N and suppression of interference by Al in this interaction. The etching property is improved mainly by means of strictly limiting Al, C, O, S, Si and P contents. In addition, the magnetic properties are improved by suppressing the upper limit of N, C and Mn to a low level.

1. A low-carbon steel sheet used for the color-selecting electrode of a bridge-attached tension type cathode-ray tube, which consists, by mass %, of from 0.001 to 0.015% of C, 0.020% or less of Si, from 0.2 to 1.8% of Mn, 0.02% or less of P, 0.010% or less of S, from more than 0.010% to 0.025% of N, 0.02% or less of Al, 0.010% or less of O, the balance being Fe and unavoidable impurities, (N mass % —0.52Al mass %) being 0.005% or more.

2. A low-carbon steel sheet used for the color-selecting electrode of a bridge-attached tension type cathode-ray tube, which consists, by mass %, of from 0.001 to 0.015% of C, 0.020% or less of Si, from 0.2 to 1.8% of Mn, 0.02% or less of P, 0.010% or less of S, from more than 0.010% to 0.025% of N, 0.020% or less of Al, 0.010% or less of O, the balance being Fe and unavoidable impurities, (N mass %—0.52Al mass %) being 0.005% or more, said sheet being rolled at from 15 to 80% of the final cold-rolling degree.

3. A low-carbon steel sheet used for the color-selecting electrode of a bridge-attached tension type cathode-ray tube according to claim 2, characterized in that the grain size prior to the final cold-rolling is from 5 to 50 μm.

4. A low-carbon steel sheet used for the color-selecting electrode of a bridge-attached tension type cathode-ray tube according to any one of claims 1 through 3, characterized in that the tensile strength in a direction perpendicular to the rolling direction is 450 to 850 MPa.

5. A low-carbon steel sheet used for the color-selecting electrode of a bridge-attached tension type cathode-ray tube according to any one of claims 1 through 4, wherein the yield strength (0.2%) in a direction perpendicular to the rolling direction is from 360 to 850 MPa.

6. A color-selecting electrode of a bridge-attached tension type cathode ray tube, characterized in that the low-carbon steel sheet according to any one of claims 1 through 5 is subjected to formation of apertures in the form of slots and then to tension and is stretched on a frame without pressing.

7. A color-selecting electrode of a bridge-attached tension type cathode-ray tube according to claim 6, characterized in that the steel sheet is heat-treated subsequently to the final cold-rolling and prior to the tension application and stretching, at a temperature of 723K (450° C.) to 823K (550° C.).

8. A color-selecting electrode of a bridge-attached tension type cathode-ray tube according to claim 7, characterized in that the low-carbon steel sheet, is subjected to blackening at a temperature of from 723K (450° C.) to 823K (550° C.).

9. A color selecting electrode of a bridge-attached tension type cathode ray tube according to claims 7 and 8, characterized in that the heat-treatment set forth in claim 7 and the blackening set forth in claim 8 are simultaneously carried out.

10. A color-selecting electrode of a bridge-attached tension type cathode-ray tube according to any one of claims 6 through 9, characterized in that the tensile stress is from 100 MPa to 300 MPa.

11. A cathode-ray tube, which comprises the color-selecting electrode of a bridge-attached tension mask according to any one of claims 6 through 10.
